(19) United States
(12) Patent Application Publication
(10) Pub. No.: US 2007/0038365 A1
(43) Pub. Date: Feb. 15, 2007

(54) APPARATUS AND METHOD FOR REGISTERING NON-REGISTRATION ROAD IN CAR NAVIGATION SYSTEM

(76) Inventors: Keun Baeg An, Icheon-Shi (KR); Hyun Ju Min, Icheon-Shi (KR)

Correspondence Address: IPLA P.A., 3580 WILSHIRE BLVD., 17TH FLOOR, LOS ANGELES, CA, 90010, US

(21) Appl. No.: 11/423,057

(22) Filed: Jun. 8, 2006

(30) Foreign Application Priority Data
Jul. 26, 2005 (KR) 10-2005-0067906

(51) Int. Cl. G01C 21/00

(52) U.S. Cl. 701/200

(57) ABSTRACT

An apparatus and method for registering a non-registration road in a car navigation system is provided. The apparatus includes a display unit for displaying a road based on map information and new road information; a controller for controlling to, if a current driving road is out of matching with the map information, determine whether or not the current driving road is a road not registered and, if the current driving road is the road not, when number of times of out of matching of the current driving road is greater than a set number of times, detect a type of a road just before the current driving road is out of matching, prepare new road information, and store the prepared new road information in a memory; and the memory for storing the map information and the new road information.

### BACKGROUND OF THE INVENTION

1. Field of the Invention

The present invention relates to an apparatus and method for registering a non-registration road in a car navigation system, and more particularly, to an apparatus and method for preparing road information not registered on map information as new road information, and displaying and utilizing the new road information.

2. Description of the Related Art

In recent years, as a car is considered to be indispensable, in addition to devices such as an engine necessary for driving the car, various devices providing various conveniences to a driver, for example, a car navigation system is under research and development. In the car navigation system embodied as an intelligent transport system (ITS), position information using a global positioning system (GPS) satellite is introduced into the car, and provides the driver with a situation of a peripheral road centering on a current position of the car.

In other words, the car navigation system refers to a system for detecting the position information of the car using the GPS information received from the GPS satellite, searching for position information previously stored in a compact disk read only memory (CD-ROM), using the detected position information, and providing map information corresponding to the detected position information. As described above, the car navigation system provides the map information based on the current position information of the car so that the driver can be provided with detailed position information even in an unfamiliar area, thereby increasing a driver's convenience.

However, the car navigation system displays only a road registered on the map information and therefore, it is not possible to display the road not registered on the map information when it is difficult to promptly upgrade the map information. Accordingly, there is a drawback in that even though the driver continuously drives on the same road, he/she cannot be accurately guided by the car navigation system.

### SUMMARY OF THE INVENTION

Accordingly, the present invention is directed to an apparatus and method for registering a non-registration road in a car navigation system that substantially overcome one or more of the limitations and disadvantages of the conventional art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an apparatus for registering a non-registration road in a car navigation system, the apparatus including: a display unit for displaying a road based on map information and new road information, under a predetermined control; a controller for controlling to, when it is determined that a current driving road is out of matching with the map information, determine whether or not the current driving road is a road not registered on the map information and, if it is determined as the determination result that the current driving road is the road not registered on the map information, when number of times of out of matching of the current driving road with the map information is greater than a set number of times, detect a type of a road just before the current driving road is out of matching with the map information, prepare new road information correspondingly to the road type and a current position, and store the prepared new road information in a memory; and the memory for storing the map information and the new road information.

In another aspect of the present invention, there is provided a method for registering a non-registration road in a car navigation system, the method including the steps of: if it is determined that a current driving road is out of matching with map information, determining whether or not the current driving road is a road not registered on the map information; if it is determined as the determination result that the current driving road is the road not registered on the map information, determining whether or not number of times of out of matching of the current driving road with the map information is greater than a set number of times; if it is determined as the determination result that the number of times of out of matching of the current driving road with the map information is greater than the set number of times, detecting a type of a road just before the current driving road is out of matching with the map information; preparing new road information correspondingly to the road type and a current position; and storing the prepared new road information in a memory.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates an internal construction of an apparatus for registering a non-registration road in a car navigation system for performing a function according to an embodiment of the present invention;

FIG. 2 is a flowchart illustrating a procedure of preparing a new road in an apparatus for registering a non-registration road in a car navigation system according to an embodiment of the present invention;

FIG. 3 is a flowchart illustrating a procedure of displaying a new road in an apparatus for registering a non-registration road in a car navigation system according to an embodiment of the present invention; and

FIG. 4 is a flowchart illustrating a procedure of utilizing a new road in an apparatus for registering a non-registration road in a car navigation system according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention provides an apparatus and method for registering a non-registration road in a car navigation system. In particular, the present invention provides the apparatus and method for preparing road information not registered on map information as new road information, and displaying and utilizing the new road information in the car navigation system.

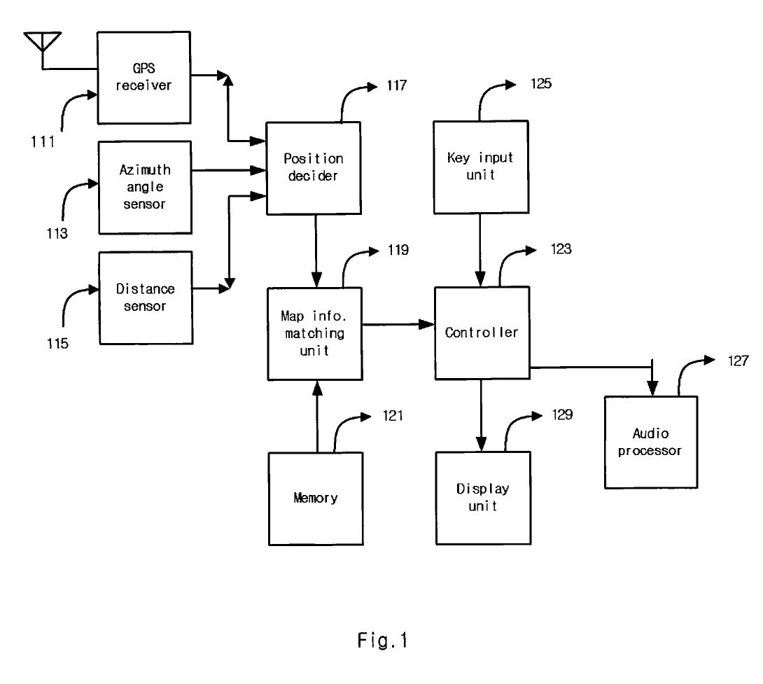

FIG. 1 is a block diagram illustrating an internal construction of the apparatus for registering the non-registration road in the car navigation system for performing a function according to an embodiment of the present invention.

Referring to FIG. 1, the inventive apparatus includes a global positioning system (GPS) receiver 111, an azimuth angle sensor 113, a distance sensor 115, a position decider 117, a map information matching unit 119, a memory 121, a controller 123, a key input unit 125, an audio processor 127, and a display unit 129.

The GPS receiver 111 receives information from a GPS satellite, and outputs the received GPS satellite information to the position decider 117. The GPS satellite information can be information capable of deciding information on a driving state of a vehicle, that is, azimuth angle and speed information. The azimuth angle sensor 113 is installed at a suitable position of the vehicle, and senses an azimuth angle depending on driving of the vehicle and outputs the sensed azimuth angle to the position decider 117. The azimuth angle sensor 113 can be a gyro sensor. The distance sensor 115 is installed at a suitable place of the vehicle like the azimuth angle sensor 113, and senses a movement distance depending on the driving of the vehicle when the vehicle is driven and outputs the sensed movement distance to the position decider 117.

The position decider 117 receives the GPS satellite information, the azimuth angle, and the movement distance from the GPS receiver 111, the azimuth angle sensor 113, and the distance sensor 115, respectively, and detects a current position of the vehicle and outputs the detected current position to the map information matching unit 119. An operation of detecting the current position of the vehicle in the position decider 117 has no direct relation with the present invention and therefore, its detailed description will be omitted.

The map information matching unit 119 receives information on the current position of the vehicle from the position decider 117, accurately matches the received current position to map information stored in the memory 121, and outputs the matched map information to the controller 123.

The key input unit 125 includes a plurality of keys and, particularly, includes keys for setting an operation mode of the car navigation system. It is of course that the keys for setting the operation mode of the car navigation system can be new keys, or a combination of the plurality of keys.

The audio processor 127 audio processes and outputs an alert message stored in the memory 121 under the control of the controller 123.

The display unit 129 can be comprised of devices such as a liquid crystal display (LCD) unit or a light emitting diode (LED). The display unit 129 displays the map information, that is, new road information according to an embodiment of the present invention provided from the map information matching unit under the control of the controller 123. The display unit 129 displays the alert message stored in the memory 121 under the control of the controller 123.

The controller 123 controls a general operation of the car navigation system and, in particular, controls an operation of preparing, displaying, or utilizing the new road information.

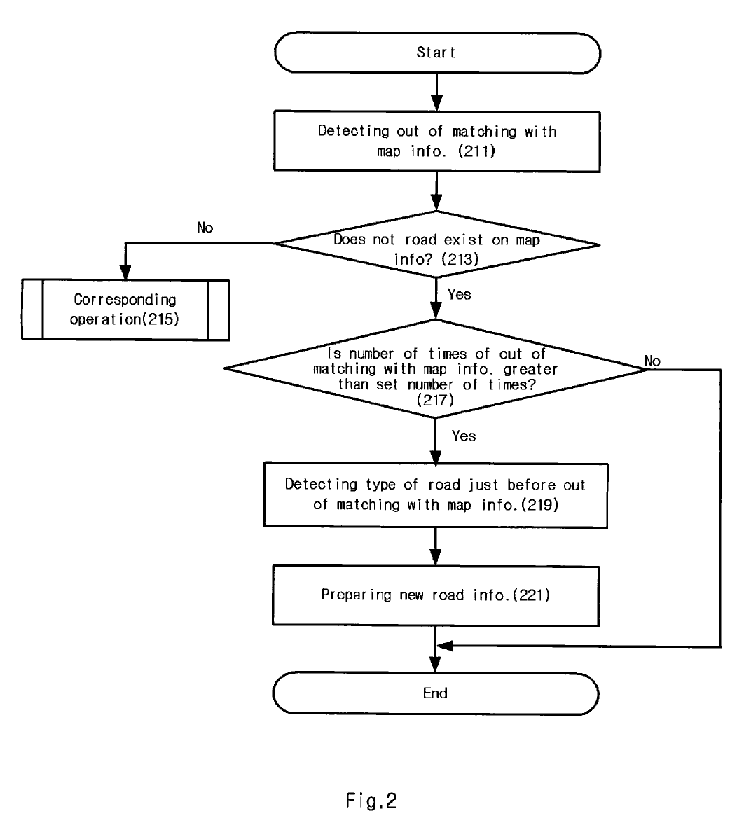

FIG. 1 illustrates the internal construction of the apparatus for registering the non-registration road in the car navigation system for performing the function according to an embodiment of the present invention. Next, with reference to FIG. 2, a procedure of preparing the new road information in the apparatus for registering the non-registration road in the car navigation system according to an embodiment of the present invention will be described.

FIG. 2 is a flowchart illustrating the procedure of preparing the new road information in the apparatus for registering the non-registration road in the car navigation system according to an embodiment of the present invention.

Referring to FIG. 2, in Step 211, the inventive apparatus detects that a current driving road is out of range of the previously registered map information, and proceeds with Step 213. In the Step 213, the apparatus determines whether or not the current driving road is within the range of the map information. If it is determined as a determination result that the current driving road is within the range of the map information, the apparatus proceeds with Step 215. In the Step 215, the apparatus performs a corresponding operation according to the out of the range of the map information, and ends.

If it is determined in the Step 213 that the current driving road is out of the range of the map information, the apparatus proceeds with Step 217. In the Step 217, the apparatus determines whether or not number of times of out of the range of the map information is greater than a previously set number of times. If it is determined as the determination result that the number of times of out of the range of the map information is greater than the previously set number of times, the apparatus proceeds with Step 219. In the Step 219, the apparatus detects a type of a road just before the current driving road is out of the range of the map information, and proceeds with Step 221. In the Step 221, the apparatus prepares the new road information, which corresponds to the road type and the current position information just before the current driving road is out of the range of the map information, stores the prepared new road information in the memory, and ends.

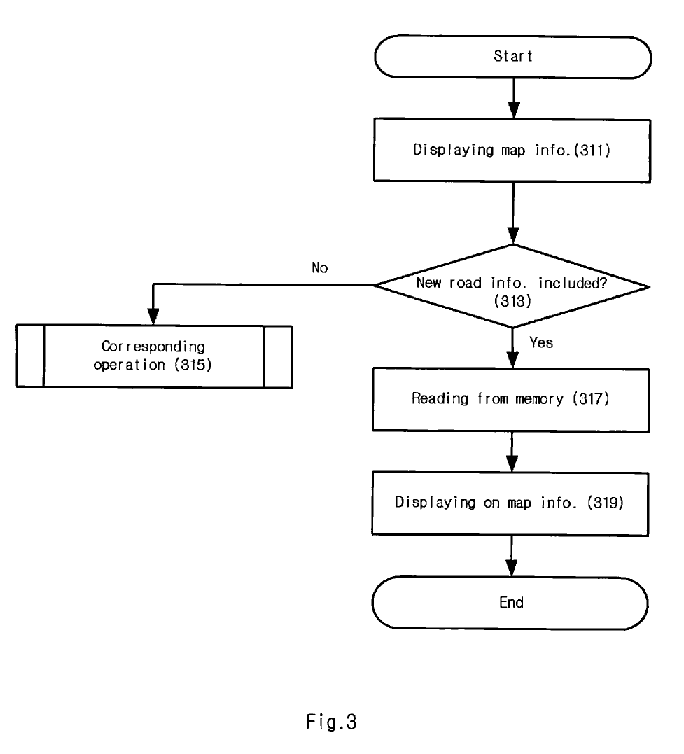

In FIG. 2, the procedure of preparing the new road information in the apparatus for registering the non-registration road in the car navigation system according to an embodiment of the present invention is described, and next, with reference to FIG. 3, a procedure of displaying the new road information in the apparatus for registering the non-registration road in the car navigation system according to an embodiment of the present invention will be described.

FIG. 3 illustrates the procedure of displaying the new road information in the apparatus for registering the non-registration road in the car navigation system according to an embodiment of the present invention.

Referring to FIG. 3, in Step 311, the apparatus displays the map information while determining whether or not to include the new road information in Step 313. If it is determined as the determination result not to include the new road information, the apparatus proceeds with Step 315. In the Step 315, the apparatus performs a corresponding operation according to the displaying of the general map information, and ends.

If it is determined as the determination result to include the new road information in the Step 315, the apparatus proceeds with Step 317. In the Step 317, the apparatus reads from the memory and detects the new road information, and proceeds with Step 319. In the Step 319, the apparatus displays the detected new road information on the map information, and ends. The new road information is information on the road not registered on the map information. Therefore, the new road information is displayed with a different color and distinguished from a road registered on the map information.

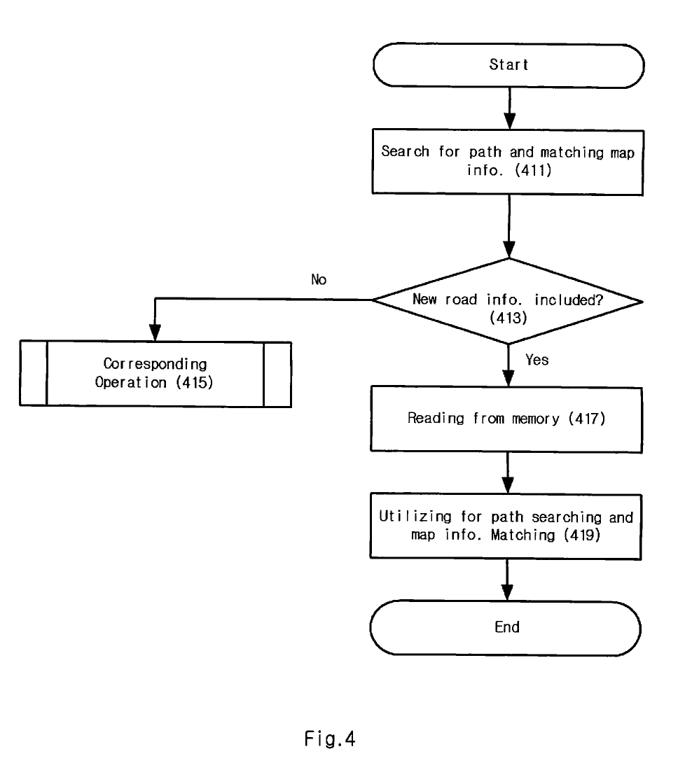

In FIG. 3, the procedure of displaying the new road information in the apparatus for registering the non-registration road in the car navigation system according to an embodiment of the present invention is described. Next, with reference to FIG. 4, a procedure of utilizing the new road in the apparatus for registering the non-registration road in the car navigation system according to an embodiment of the present invention will be described.

FIG. 4 is a flowchart illustrating the procedure of utilizing the new road in the apparatus for registering the non-registration road in the car navigation system according to an embodiment of the present invention.

Referring to FIG. 4, in Step 411, the apparatus searches for a path and matches the map information while determining whether or not to include the new road information in Step 413. If it is determined as the determination result not to include the new road information, the apparatus proceeds with Step 415. In the Step 415, the apparatus performs a corresponding operation according to the general path searching and map information matching operation, and ends.

If it is determined as the determination result of the Step 413 to include the new road information, the apparatus proceeds with Step 417. In the Step 417, the apparatus utilizes the detected new road information for searching for the path and matching the map information, and ends. The new road information is information on a road not registered on the map information. Therefore, the new road information is displayed with the different color and distinguished from the road registered on the map information.

As described above, the present invention provides the apparatus and method for preparing the road information not registered on the map information as the new road information, and displaying and utilizing the new road information in the car navigation system, thereby maximizing a user convenience even when the map information is not smoothly upgraded.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An apparatus for registering a non-registration road in a car navigation system, the apparatus comprising:
a display unit for displaying a road based on map information and new road information, under a predetermined control;
a controller for controlling to, when it is determined that a current driving road is out of matching with the map information, determine whether or not the current driving road is a road not registered on the map information and, if it is determined as the determination result that the current driving road is the road not registered on the map information, when number of times of out of matching of the current driving road with the map information is greater than a set number of times, detect a type of a road just before the current driving road is out of matching with the map information, prepare new road information correspondingly to the road type and a current position, and store the prepared new road information in a memory; and
the memory for storing the map information and the new road information.

2. The apparatus according to claim 1, wherein, when it is determined to include the new road information while the map information is displayed, the controller reads the new road information from the memory, distinguishes the read new road information with a different color from roads previously registered on the map information, and displays the distinguished new road information.

3. The apparatus according to claim 1, wherein, when it is determined to include the new road information while the map information is searched, the controller reads the new road information from the memory, utilizes the read road information for searching the map information, distinguishes the read new road information with a different color from roads previously registered on the map information, and displays the distinguished new road information.

4. A method for registering a non-registration road in a car navigation system, the method comprising the steps of:
if it is determined that a current driving road is out of matching with map information, determining whether or not the current driving road is a road not registered on the map information;
if it is determined as the determination result that the current driving road is the road not registered on the map information, determining whether or not number of times of out of matching of the current driving road with the map information is greater than a set number of times;
if it is determined as the determination result that the number of times of out of matching of the current driving road with the map information is greater than the set number of times, detecting a type of a road just before the current driving road is out of matching with the map information;
preparing new road information correspondingly to the road type and a current position; and
storing the prepared new road information in a memory.

5. The method according to claim 4, further comprising the step of, when it is determined to include the new road information while the map information is displayed, reading the new road information from the memory, distinguishing the read new road information with a different color from roads previously registered on the map information, and displaying the distinguished new road information.

6. The method according to claim 4, further comprising the step of, when it is determined to include the new road information while the map information is searched, reading the new road information from the memory, utilizing the read road information for searching the map information, distinguishing the read new road information with a different color from roads previously registered on the map information, and displaying the distinguished new road information.
